(19) United States
(12) Patent Application Publication
(10) Pub. No.: US 2006/0114214 A1
(43) Pub. Date: Jun. 1, 2006

(54) Image rotation in display systems

(76) Inventors: Dwight Griffin, San Jose, CA (US); Peter Richards, San Francisco, CA (US)

Correspondence Address: Gregory R. Muir;Reflectivity, Inc., 350 Potrero Avenue, Sunnyvale, CA, 94085, US

(21) Appl. No.: 11/329,763

(22) Filed: Jan. 11, 2006

Related U.S. Application Data
(63) Continuation-in-part of application No. 10/648,689, filed on Aug. 25, 2003.

(51) Int. Cl. G09G 3/36

(52) U.S. Cl. 345/98

(57) ABSTRACT

The present invention provides a method and apparatus of converting a stream of pixel data representing an image in the first orientation in space and time into a stream of bitplane data representing an image in the second orientation. The second orientation can be a horizontal, vertical, or a combination of thereof of the first orientation. The method of the invention can be performed in a “real-time” fashion, and dynamically performs predefined transformation, or alternatively performed in by a functional module implemented in a computer readable medium stored in a computing device.

### CROSS-REFERENCE TO RELATED CASES

The present patent application is a continuation-in-part of U.S. patent application Ser. No. 10/648,689 filed Aug. 25, 2003, the subject matter of which is incorporated herein by reference in entirety.

### TECHNICAL FIELD OF THE INVENTION

The present invention is related generally to the art of digital display systems using spatial light modulators such as micromirror arrays or ferroelectric LCD arrays, and more particularly, to methods and apparatus for rotating images in the systems.

### BACKGROUND OF THE INVENTION

In current digital display systems using micromirror arrays or other similar spatial light modulators such as ferroelectric LCDs and plasma displays, the orientation of produced images are often fixed relative to the body of the display systems. This certainly limits the freedom of the user in installing the display systems. For example, if the display system is designed to be operated with the body of the display system being disposed horizontally, flipping the body of the display system vertically will result in the flipping of the produced image. In many other situations where user intent to attach the display system on the wall with the body of the display system flipped vertically, or hang on the ceiling with the body of the display system being flipped up side down, the produced images will also be flipped, which is not viewable by the user.

Therefore, it is desired to provide a method and apparatus for flipping the projected images in digital display systems.

### SUMMARY OF THE INVENTION

In view of the forgoing, an objective of the invention is to provide a method and apparatus for flipping the images such that the projected images are in normal orientation regardless whether the display systems are disposed horizontally or vertically.

Another objective of the present invention is to provide a method and apparatus to allow the optics in the display systems to be designed according to other criteria without the constraint of image orientation being a factor.

Such objects of the invention are achieved in the features of the independent claims attached hereto. Preferred embodiments are characterized in the dependent claims.

### BRIEF DESCRIPTION OF DRAWINGS

While the appended claims set forth the features of the present invention with particularity, the invention, together with its objects and advantages, may be best understood from the following detailed description taken in conjunction with the accompanying drawings of which:

FIG. 1A illustrates a projected image in the normal orientation;

FIG. 1B illustrates the image of FIG. 1A being flipped horizontally;

FIG. 1C illustrates the image of FIG. 1A being flipped vertically;

FIG. 1D illustrates the image of FIG. 1A being flipped horizontally and vertically;

FIG. 2 illustrate an exemplary display system using a spatial light modulator having an array of micromirrors;

FIG. 3 is a diagram schematically illustrating a cross-sectional view of a portion of a row of the micromirror array and a controller connected to the micromirror array for controlling the states of the micromirrors of the array;

FIG. 4 illustrates an exemplary memory cell array used in the spatial light modulator of FIG. 2;

FIG. 5 illustrates the operation of the functional modules in the controller of FIG. 2 according to an embodiment of the invention;

FIG. 6 illustrates an exemplary method of dividing the pixels into sections according to an embodiment of the invention;

FIG. 7 illustrates an exemplary image row in RGB raster format;

FIG. 8 illustrates an exemplary image row in planarized format;

FIG. 9 illustrates an exemplary image row stored in the frame buffer in FIG. 2;

FIG. 10 summarizes the image row regions of the frame buffer in FIG. 2;

FIG. 11a to FIG. 11K illustrate retrieval processes of the bitplane data from the frame buffer of the display system to the pixels of the spatial light modulator;

FIG. 12 and FIG. 13 illustrate the bitplane data being flipped horizontally;

FIG. 14 illustrates an exemplary operation of the data queue in FIG. 5 for flipping the image horizontally; and

FIG. 15 illustrates an exemplary operation of the data queue in FIG. 5 for flipping the image vertically according to an embodiment of the invention.

### DETAILED DESCRIPTION OF THE EMBODIMENTS

The present invention provides a method and apparatus of flipping the projected images without impact the optical configuration of the optical components in the display systems. Embodiments of the present invention can be implemented in a variety of ways and display systems. In the following, embodiments of the present invention will be discussed in a display system that employs a micromirror array and a pulse-width-modulation technique, wherein individual micromirrors of the micromirror array are controlled by memory cells of a memory cell array. It will be understood by those skilled in the art that the embodiments of the present invention are applicable to any grayscale or color pulse-width-modulation methods or apparatus, such as those described in U.S. Pat. No. 6,388,661, and U.S. patent application Ser. No. 10/340,162, filed Jan. 10, 2003, both to Richards, the subject matter of each being incorporated herein by reference. Each memory cell of the memory cell array can be a standard ITIC (one transistor and one capacitor) circuit. Alternatively, each memory cell can be a “charge-pump-memory cell” as set forth in U.S. patent application Ser. No. 10/340,162 filed Jan. 10, 2003 to Richards, the subject matter being incorporated herein by reference. A charge-pump-memory-cell comprises a transistor having a source, a gate, and a drain; a storage capacitor having a first plate and a second plate; and wherein the source of said transistor is connected to a bitline, the gate of said transistor is connected to a wordline, and wherein the drain of the transistor is connected to the first plate of said storage capacitor forming a storage node, and wherein the second plate of said storage capacitor is connected to a pump signal. It will be apparent to one of ordinary skills in the art that the following discussion applies generally to other types of memory cells, such as DRAM, SRAM or latch. The wordlines for each row of the memory array can be of any suitable number equal to or larger than one, such as a memory cell array having multiple wordlines as set forth in U.S. patent application “A Method and Apparatus for Selectively Updating Memory Cell Arrays” filed Apr. 2, 2003 to Richards, the subject matter being incorporated herein by reference. For clarity and demonstration purposes only, the embodiments of the present invention will be illustrated using binary-weighted PWM waveforms. It is clear that other PWM waveforms (e.g. other bit-depths and/or non binary weightings) may also be applied. Furthermore, although not limited thereto, the present invention is particularly useful for operating micromirrors such as those described in U.S. Pat. No. 5,835,256, the contents of which are hereby incorporated by reference.

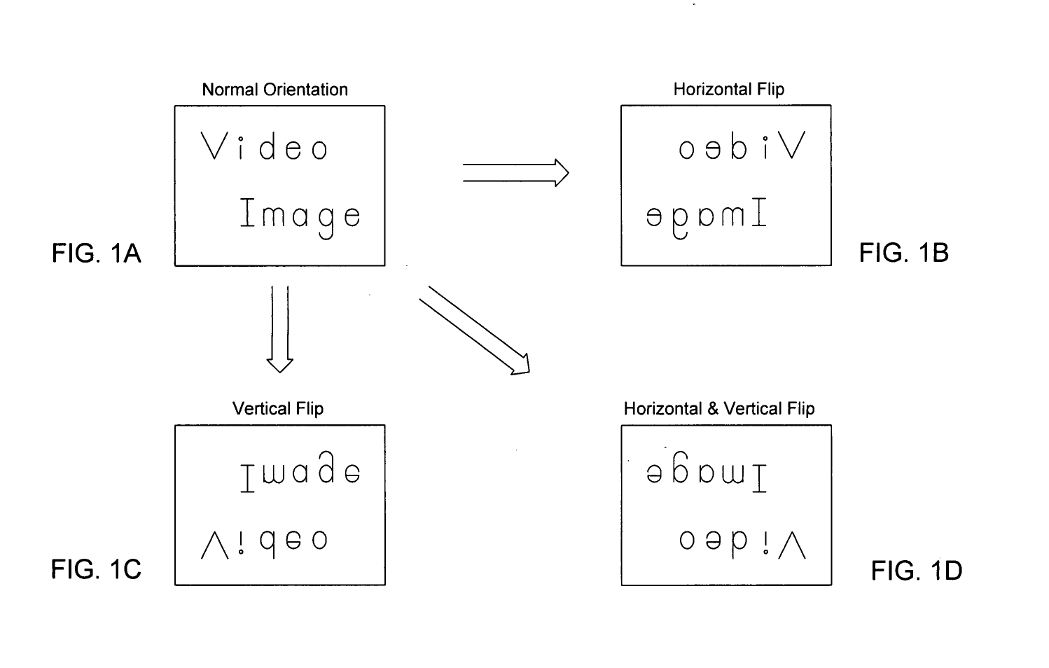

Turning to the drawings, FIG. 1A to FIG. 1D illustrate the flipping effect of an image in normal orientation according to the invention. Specifically, the “video image” in FIG. 1A is projected in the normal direction. The horizontally flipped “video image” is illustrated in FIG. 1B; and the vertically flipped “video image” is illustrated in FIG. 1C. The “video image” after the combination of vertical and horizontal flip is illustrated in FIG. 1D. Such operation in digital systems employing a micromirror array based spatial light modulator or the like, such as LCD and plasma display systems can be achieved by manipulating the image data in the digital display system without impacting the optical design of the components in the digital display systems.

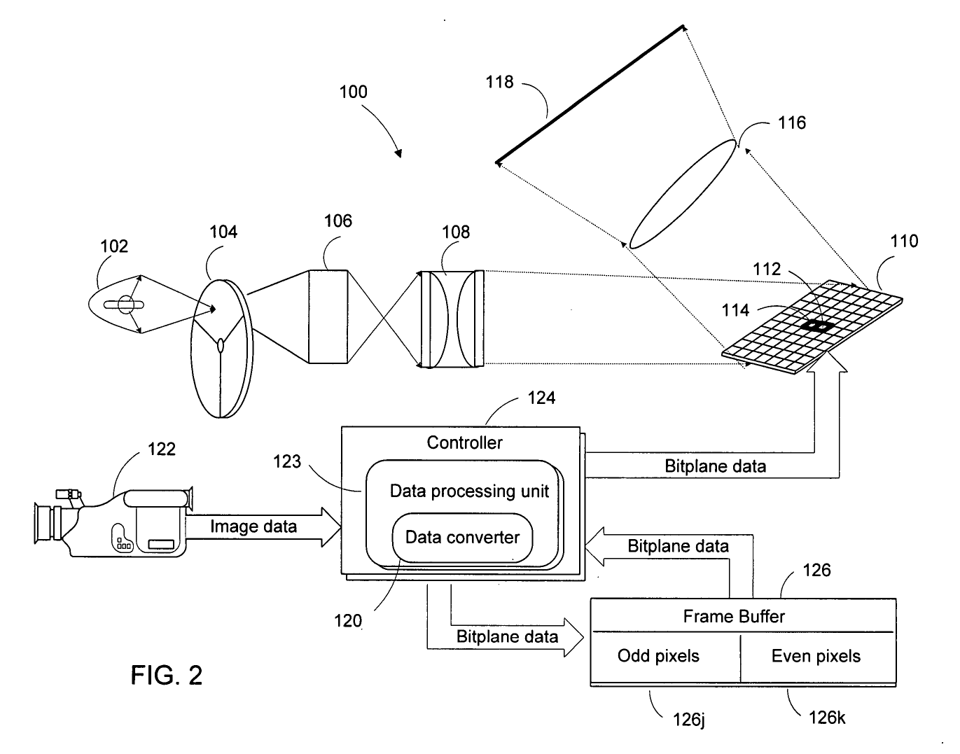

As a way of example, FIG. 2 illustrates a simplified display system using a spatial light modulator having a micromirror array, in which embodiments of the present invention can be implemented. In its basic configuration, display system 100 comprises light source 102, optical devices (e.g. light pipe 106, condensing lens 108 and projection lens 116), display target 118, spatial light modulator 110 that further comprises an array of micromirrors (e.g. micromirrors 112 and 114), and controller 124 (e.g. as disclosed in U.S. Pat. No. 6,388,661 issued May 14, 2002 incorporated herein by reference). The data controller comprises data processing unit 123 that further comprises data converter 120. Color filter 104 may be provided for creating color images.

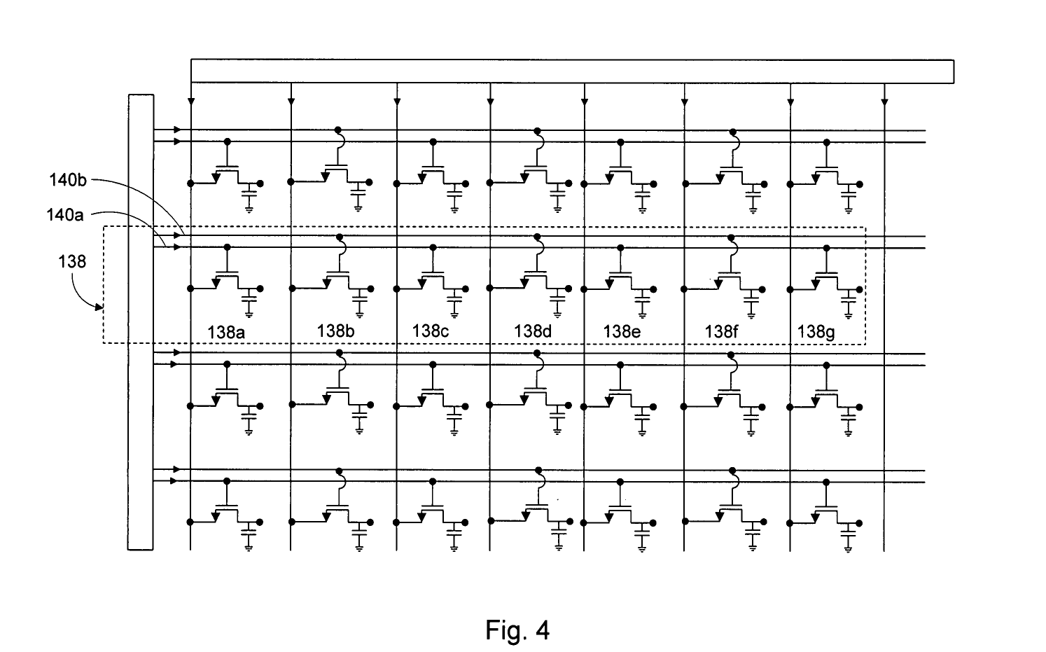

Light source 102 (e.g. an arc lamp) emits light through color filter 104, light integrator/pipe 106 and condensing lens 108 and onto spatial light modulator 110. Each pixel (e.g. pixel 112 or 114) of spatial light modulator 110 is associated with a pixel of an image or a video frame. The pixel of the spatial light modulator operates in binary states—an ON state and an OFF state. In the ON state, the pixel reflects incident light from the light source into projection lens 116 so as to generate a “bright” pixel on the display target. In the OFF state, the pixel reflects the incident light away from projection optics 116—resulting in a “dark” pixel on the display target. The states of the pixels of the spatial light modulator is controlled by a memory cell array, such as the memory cell arrays illustrated in FIG. 4, which will be discussed afterwards.

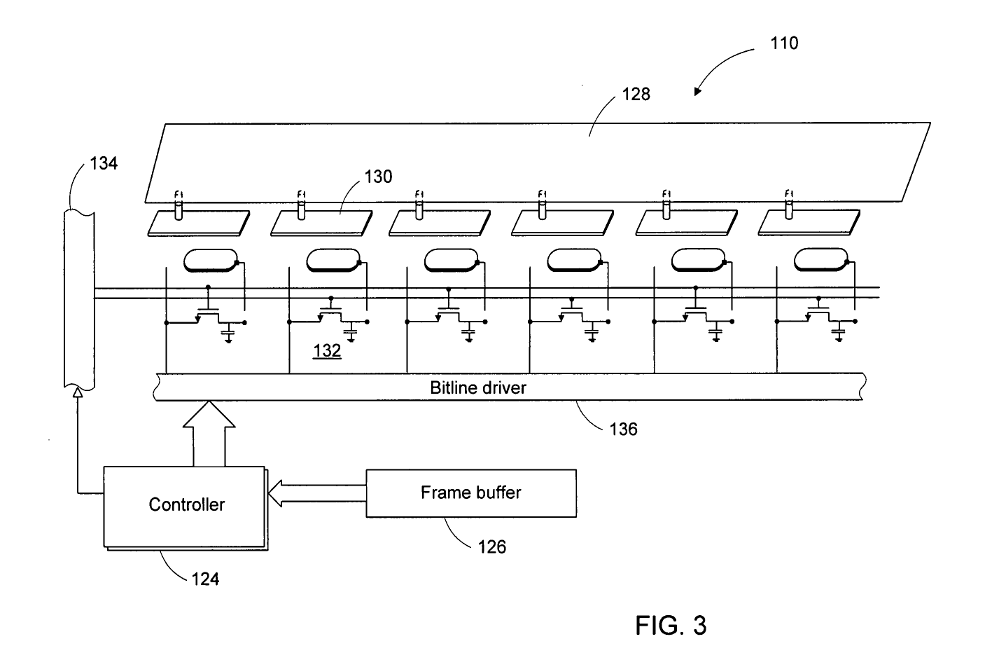

A micromirror typically comprises a movable mirror plate that reflects light and a memory cell disposed proximate to the mirror plate, which is better illustrated in FIG. 3. Referring to FIG. 3, a cross-sectional view of a portion of a row of the micromirror array of spatial light modulator 110 in FIG. 2 is illustrated therein. Each mirror plate is movable and associated with an electrode and memory cell. For example, mirror plate 130 is associated with memory cell 132 and an electrode that is connected to a voltage node of the memory cell. In other alternative implementations, each memory cell can be associated with a plurality of mirror plates. Specifically, each memory cell is connected to a plurality of pixels (e.g. mirror plates) of a spatial light modulator for controlling the state of those pixels of the spatial light modulator. An electrostatic field is established between the mirror plate and the electrode. In response to the electrostatic field, the mirror plate is rotated to the ON state or the OFF state. The data bit stored in the memory cell (the voltage node of the memory cell) determines the electrostatic field, thus determines whether the mirror plate is on or off.

The memory cells of the row of the memory cell array may be connected to dual wordlines for activating the memory cells of the row, which will be discussed in detail with reference to FIG. 4 afterwards. Each memory cell is connected to a bitline, and the bitlines of the memory cells are connected to bitline driver 136. In operation, controller 124 initiates an activation of selected memory cells by sending an activation signal to decoder 134. The decoder activates the selected memory cells by activating the wordline connected to the selected memory cells. Meanwhile, the controller retrieves a plurality of bitplane data to be written to the selected memory cells from frame buffer 126 and passes the retrieved bitplane data to the bitline driver, which then delivers the bitplane data to the selected memory cells that are activated.

The memory cells of the row are connected to a plurality of wordlines (, though only two wordlines are presented in the figure), such as the multiple wordline in memory cell array as disclosed in U.S. patent application Ser. No. 10/407,061 filed Jul. 2, 2003, the subject matter being incorporated herein by reference. The provision of the multiple wordline enables the memory cells of the row to be selectively updated. The timing of update events to neighboring memory cells of the row can thus be decorrelated. This configuration is especially useful in digital display systems that use a pulse-width-modulation technique. Artifacts, such as dynamic-false-contouring artifacts can be reduced or eliminated. Therefore, the perceived quality of the images or video frames is improved.

In order to selectively update memory cells of a row of a memory cell array, the memory cells of the row are divided into subgroups according to a predefined criterion. For example, a criterion directs that neighboring memory cells in a row are grouped into separate subgroups. A portion of a memory cell array complying with such rule is illustrated in FIG. 4. Referring to FIG. 4, for example, memory cell row 138 of the memory cell array comprises memory cells 138a, 138b, 138c, 138d, 138e, 138f, and 138g. These memory cells are divided into subgroups according to a predefined criterion, which directs that adjacent memory cells are in different subgroups. In this figure, the memory cells are divided into two subgroups. One subgroup comprises odd numbered memory cells, such as 138a, 138c, 138e and 138g. Another subgroup comprises even numbered memory cells, such as 138b, 138d and 138f. These memory cells are connected to wordlines 140a and 140b such that memory cells of the same subgroup are connected to the same wordline and the memory cells are connected to separate wordlines. Specifically, the odd numbered memory cells 138a, 138c, 138e and 138g are connected to wordline 140a. And even numbered memory cells 138b, 138d and 138f are connected to wordline 140b.

Because the memory cells of a row of the memory cell array in different subgroups are connected to separate wordlines, the memory cells can be activated or updated independently by separate wordlines. Memory cells in different subgroups of the row can be activated asynchronously or synchronously as desired by scheduling the activation events of the wordlines. Moreover, memory cells in different rows of the memory cell array can be selectively updated asynchronously or synchronously as desired. For example, one can simultaneously update memory cells in a subgroup (e.g. even numbered memory cells) of a row and memory cells in another subgroup (e.g. odd numbered memory cells) of a different row. Of course, memory cells in different subgroups of different rows can be activated at different times.

In digital display system, the memory cell array is part of a spatial light modulator that comprises an array of pixels, each of which corresponds to a pixel of an image or a video frame and the modulation states of the pixels of the spatial light modulator are controlled by the memory cell array. Because the memory cells of the memory cell array are individually addressable and decorrelated by the provision of multiple wordlines, the pixels of the spatial light modulator are also individually controllable and decorrelated. As a consequence, artifacts, such as the dynamic-false-contouring artifacts are in displayed images or video frames are reduced or eliminated.

In FIGS. 3 and 4, the memory cells are illustrated as standard ITIC memory cells. It should be understood than this is not an absolute requirement. Instead, other memory cells, such as a charge-pump-memory cell, DRAM or SRAM could also be used. Moreover, the memory cells of each row of the memory cell array could be provided with more than one wordline for addressing the memory cells. In particular, two wordlines could be provided for each row of memory cells of the memory cell array as set forth in U.S. patent application Ser. No. 10/340,162 filed Jan. 10, 2003, the subject matter being incorporated herein by reference.

The controller 124 as shown in FIGS. 2 and 3 can be configured in many ways, one of which is discussed in U.S. patent application Ser. No. 10/698,290 filed Oct. 30, 2003, the subject matter being incorporated herein by reference, and will not be discussed in detail herein.

In order to achieve various levels of perceived light intensity by human eyes using PWM, each pixel of a grayscale image is represented by a plurality of data bits. Each data bit is assigned significance. Each time the micromirror is addressed, the value of the data bit determines whether the addressed micromirror is on or off. The bit significance determines the duration of the micromirror's on or off period. The bits of the same significance from all pixels of the image are called a bitplane. If the elapsed time the micromirrors are left in the state corresponding to each bitplane is proportional to the relative bitplane significance, the micromirrors produce the desired grayscale image.

In practice, the memory cells associated with the micromirror array are loaded with a bitplane at each designated addressing time. During a frame period, a number of bitplanes are loaded into the memory cells for producing the grayscale image; wherein the number of bitplanes equals the predetermined number of data bits representing the image pixels. The bitplane data can be prepared by controller 124 and frame buffer 126 as shown in FIG. 2.

Turning back to FIG. 2, controller 124 receives image data from peripheral image sources, such as video camera 122 and processes the received image data into pixel data as appropriate by data processing unit 123, which is a part of the controller. Alternatively, the data processing unit can be an independent functional unit from the controller. In this case, the data processing unit receives data from the image source and passes processed data onto the controller. Image source 122 may output image data with different formats, such as analog signals and /or digitized pixel data. If analog signals are received, the data processing unit samples the image signals and transforms the image signals into digital pixel data.

The pixel data are then received by data converter 120, which converts the pixel data into bitplane data that can be loaded into the memory cells of the memory cell array for controlling the pixels of the spatial light modulator to generate desired images or video frames.

The converted bitplane data are then delivered to and stored in a storage medium, such as frame buffer 126, which comprises a plurality of separate regions, each region storing bitplane data for the pixels of one subgroup. For demonstration purposes and simplicity purposes only, the memory cells of a row of the memory cell array are connected to two wordlines, and the even numbered memory cells and the odd numbered memory cells are connected to one of the two wordlines. Accordingly, the frame buffer comprises one region for storing bitplane data for odd numbered memory cells and another region for storing the bitplane for the even numbered memory cells. In other alternatives in which the memory cells of a row of the memory cell array are divided into a plurality of subgroups according to a predefined criterion. And a plurality of wordlines are connected to the memory cells of the row such that the memory cells of the same subgroup are connected to the same wordline and memory cells of different subgroups are connected to separate wordlines. In these cases, the frame buffer comprises a number of regions, each of which stores bitplane data for the memory cells that are to be activated at the same time based on the subgroups.

In operation, the controller activates the selected memory cells (e.g. the odd numbered memory cells of each row) by the wordlines connected to the selected memory cells (e.g. the wordlines, each of which connects the odd numbered memory cells of each row) and retrieves the bitplane data for the selected memory cells from a region (e.g. the region storing the bitplane data for the odd numbered memory cells) of the frame buffer. The retrieved bitplane data are then delivered to the activated memory cells through the bitline driver and the bitlines connecting the activated memory cells. In order to update all memory cells of the spatial light modulator using the bitplane data of the same significance, the memory cells may be selected and updated using different wordlines according to the above procedures at different times until all memory cells are updated. In practice, each memory cell will be addressed and updated a number of times during a predefined time period, such as a frame interval. And the number of times equals the number of bitplanes designated for presenting the grayscales of the image.

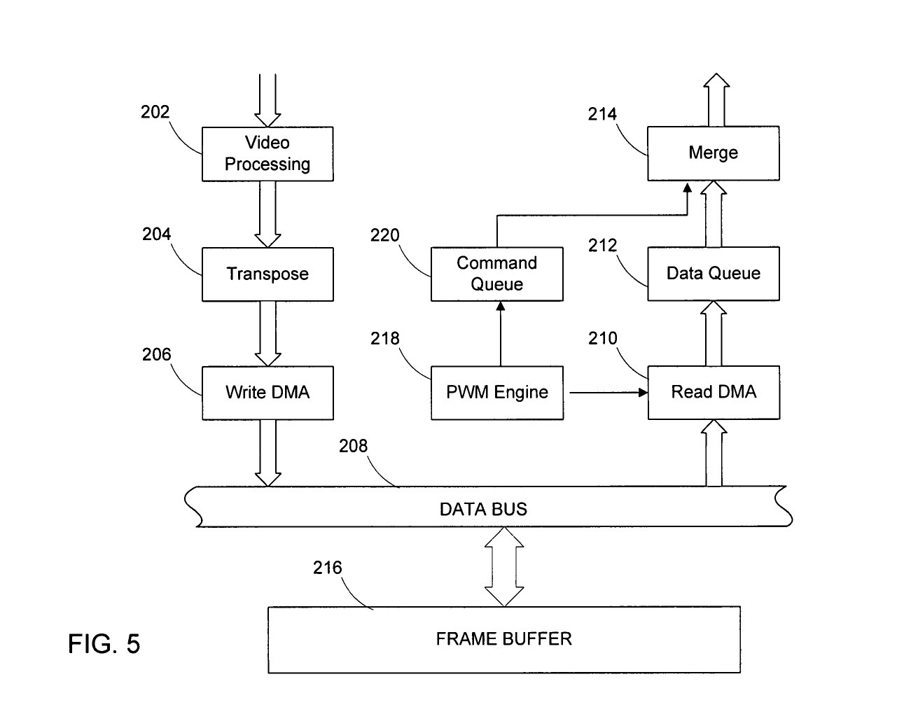

The controller (e.g. 124) can be implemented in many ways, one of which is illustrated in FIG. 5. Referring to FIG. 5, video processing unit 202 transforms the incoming RGB raster video data (f, y, xₒ) into a set of color planes (f, y, s, x), wherein f is the frame index, y is the row index, xₒ is the pixel index, s is the section index, and x is the pixel within the row and section s as will be discussed in the following.

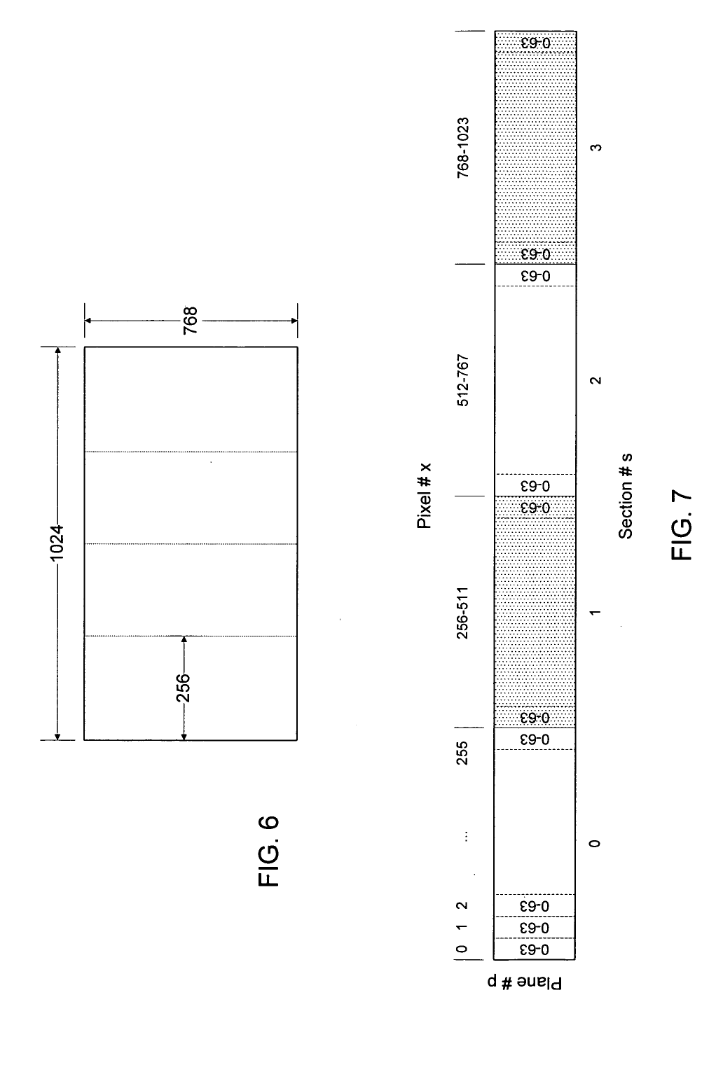

As a way of example, FIGS. 6 and 7 illustrate such transformation from RGB video stream to color planes. Referring to FIG. 6, the array of image pixels is divided into a set of sections. In the example shown in the figure, the 1024×768 pixel array is divided into four sections, each section comprising 256 pixels. Of course, the invention is applicable to other pixel arrays having larger or less number of pixels. The factor (256) used in dividing the pixel array into sections can be of other suitable values. In general, such factor depends upon the bandwidth (e.g. total number of bits per clock cycle) of the system. The divided image row in raster RGB format are illustrated in FIG. 7. The image rows comprise four sections—numbered by section 0, 1, 2, and 3. Section 0 comprises pixels 0-255; section 1 comprises pixels 256-511; section 2 comprises pixels 512-767; and section 3 comprises pixels 768-1023. By assuming each image data is represented by 64 bits (of course, each data can be represented by other number of bits such as 16, 32, and 128 bits), each pixel has 64 planes, illustrated as 0-63 in the figure.

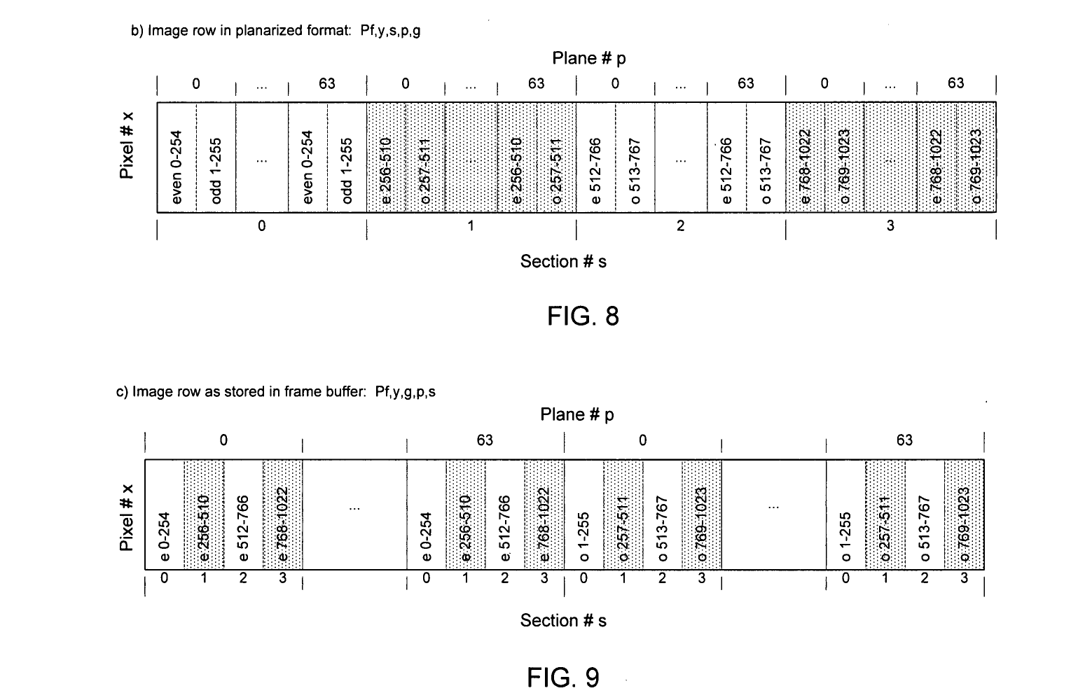

Referring back to FIG. 5, the divided image data output from the video processing unit 202 are then transposed into bitplane data in a format represented by (f y, s, p, g). f is the frame index; y is the row index within the frame f; s is the section index within the row y; p is the plane index within the section s; and g comprises two values—even (e) and odd (o), representing the even and odd numbered pixels in the row y, respectively. Specifically, the transposing unit divides a row of video image data into 256 pixel wide sections (s); slices the sections into color planes (p); and separates each slice into two halves by the even/odd pixel genders (g). The sectioned-row-plane data unit (f, y, s, p, g) contains data from 1 color plane (p) crossing 128 even/odd pixels from a particular frame (f), row (y), and section (s) of the video image data. An exemplary data structure of (f, y, s, p, g) is illustrated in FIG. 8.

Referring to FIG. 8, the image row comprises four sections—sections 0, 1, 2, and 3. Each section comprises 64 (0-63) planes. Each plane comprises 128 pixels with the even (0-254) and odd (1-255) pixels separately identified.

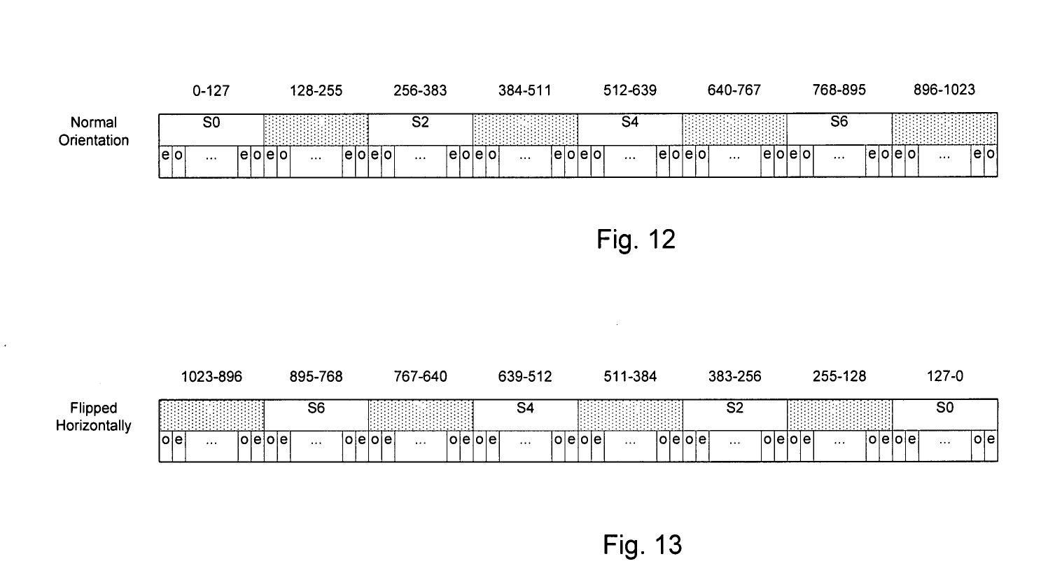

Referring again to FIG. 5, the bitplane data output from the transposing unit 204 are delivered to frame buffer 126 via data bus 208 by DMA unit 206. In performing such writing, even and odd pixels are grouped together according to their plane index p. Specifically, image data of the same plane index p (e.g. index 0, 1, 2 . . . 63) and gender g (e.g. even/odd) are arranged sequentially according to the section index s. For example, the even numbered pixels 0-254 (total number of 128 pixels), 256-510 (total number of 128 pixels), 512-766 (total number of 128 pixels), and 768-1022 (total number of 128 pixels) of sections 0, 1, 2, and 3 respectively are delivered to the frame buffer and sequentially stored therein. Each of the even and odd indexed pixel groups comprises 64 planes, as shown in the figure. It is noted that the generated bitplane data as shown in FIG. 12 may or may not be delivered to the frame buffer in the order as they are stored in the frame buffer.

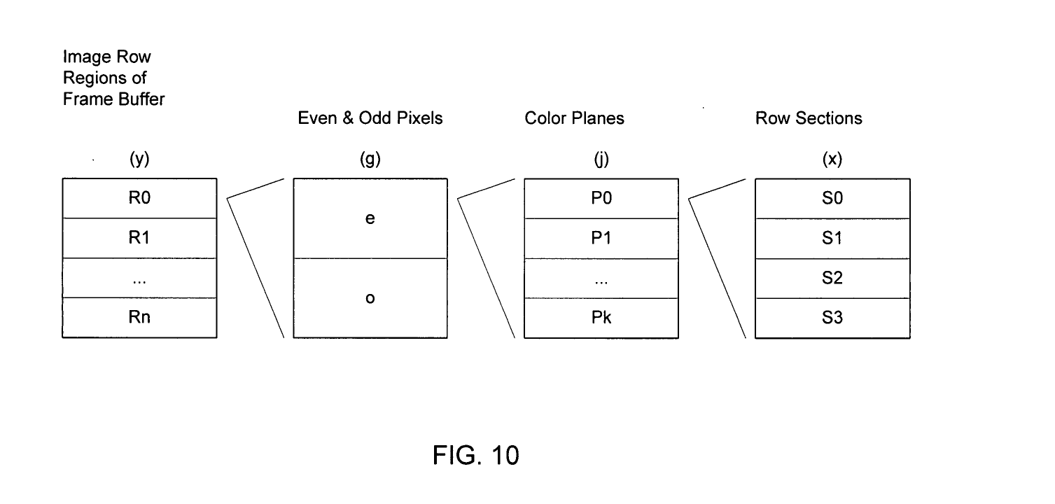

As a brief summary, a simplified data structure in the frame buffer is illustrated in FIG. 10. Referring to FIG. 10, the frame buffer comprises rows R0, R1 . . . Rn, with subscription n being the total number of rows, such as 768 rows in FIG. 6. Each row data in the frame buffer comprises even and odd numbered pixels with the even and odd numbered pixels stored consecutively. Each of the even and odd numbered data blocks comprises a set of planes indexed by P0, P1 . . . Pk; and each color plane comprises a set of row sections indexed by s0, s1, s2, and s3.

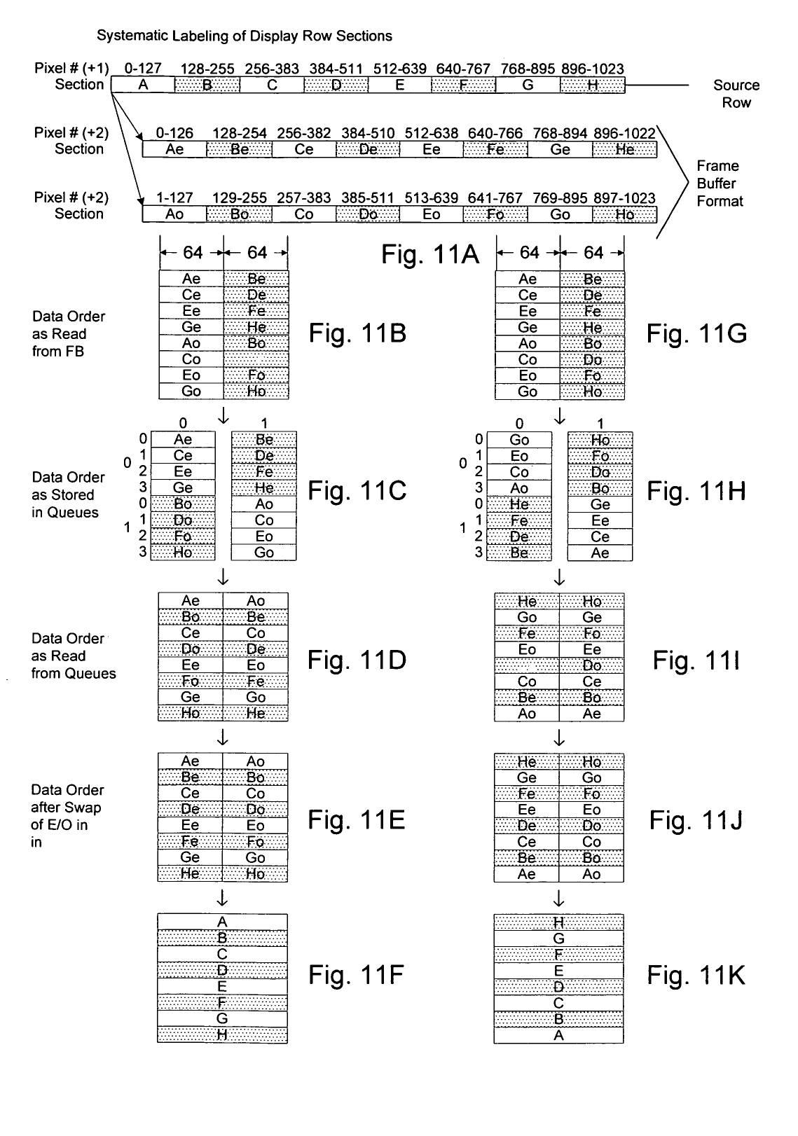

Referring again to FIG. 5, Read DMA unit 210 retrieves bitplane data from the frame buffer (126) via data bus 208 under the control of pulse-with-modulation (PWM) engine 218. Specifically, the PWM engine informs the Read DMA (210) of the pairs of row numbers (yₑ, yₒ) of the paired even and odd numbered pixels, pairs of bitplane numbers (pₑ, pₒ); and instructs the Read DMA to fetch the even-half-row-plane (yₑ, pₑ) and odd-half-row-plane (yₒ, pₒ) pairs from the frame buffer 126. The even and odd half-row-planes are then shuffled together in Data Queue 212 to form full-row-plane units of data (Pf, y, p). The PWM engine 218 gives pairs of row numbers (yₑ, yₒ) to Command Engine and Queue 216 where write commands for the display system are generated. These generated write commands along with the Read DMA fetched bitplane data are merged into a stream of display data to the spatial light modulator of the display system. According to the merged data stream, the pixels of the spatial light modulator collectively modulate the incident light so as to produce the desired video images. This bitplane data retrieval process is better illustrated in FIG. 11A, and FIG. 11B to FIG. 11F. Another process is shown in FIG. 11A, and FIG. 11G to FIG. 11K.

Referring to FIG. 11A, the data structure of the bitplane data in the frame buffer is illustrated therein. The row of the bitplane data in the frame buffer comprises eight data sections indexed by A, B, C, D, E, F, G, and H. Each data section comprises consecutively stored even (and odd) numbered pixel sub-blocks. Each sub-block of a particular gender (e.g. even numbered pixels) comprises 64 bits data (e.g. 0-126 for the even numbered sub-block Aₑ). The bitplane data in the frame buffer can be retrieved in many ways, one of which is illustrated in FIGS. 11B to 11F; and another one of which is illustrated in FIGS. 11G to 11K.

Referring to FIG. 11B, the bitplane data for the even and odd numbered pixels are read from the frame buffer in the order that the bitplane data of the even numbered pixels are retrieved in the first four data entries. Specifically, the bitplane data of the even numbered pixel in section A (Aₑ) is saved in the first 64 bits of the 128 bit-long data entry, and the bitplane of even numbered pixel in section B (Bₑ) is saved in the second 64 bits of the 128 bit-long data entry. The bitplane data of the even numbered pixels of sections C (Cₑ), E (Eₑ), and G (Gₑ) are located in the first 64 bits of the 2, 3, and 4 data entries; while the bitplane data of the even numbered pixels of sections D (Dₑ), F (Fₑ), and H (Hₑ) are located in the second 64 bits of the 2, 3, and 4 data entries. The bitplane data of the odd numbered pixels of sections A (Aₒ), C (Cₒ), E (Eₒ), and G (Gₒ) are located in the first 64 bits of the 5, 6, 7, and 8 data entries. The bitplane data of the odd numbered pixels of sections B (Bₒ), D (Dₒ), F (Gₒ), and H (Hₒ) are located in the second 64 bits of the 5, 6, 7, and 8 data entries.

The bitplane data retrieved from the frame buffer are reordered in the Data Queue. The reordered bitplane data in the Data Queue are illustrated in FIG. 11C. Referring to FIG. 11C, the bitplane data of the even numbered pixels in sections A to H are kept in the same order as they were retrieved from the frame buffer. The bitplane data of the odd numbered pixels in sections B, D, F, and H that are in the first 64 bits are swamped with the bitplane data of the odd numbered pixels in sections A, C, E, and G that are in the second 64 bits. As a result, the bitplane data of the even numbered pixels in section A, C, E, G, and the bitplane data of the odd numbered pixels in sections B, D, F, and H are in the first 64 bits of the data entries. The bitplane data of the even numbered pixels in section B, D, F, H, and the bitplane data of the odd numbered pixels in sections A, C, E, and G are in the second 64 bits of the data entries.

In outputting the bitplane data from the Data Queue, the bitplane data are shuffled by interleaving the bitplane data of the last four entries with the bitplane data of the first four entries, as shown in FIG. 11D. Referring to FIG. 11D, the bitplane data of the first 64 bits are shuffled by interleaving the bitplane data in the last four entries with those in the first four entries according to the section indices. Specifically, after the shuffle, the bitplane data of the first 64 bits are in the order of (from the top to bottom) Aₑ, Bₒ, Cₑ, Dₒ, Eₑ, Fₒ, Gₑ, and Hₒ. The bitplane data in the second 64 bits after shuffle are in the order of (from the top to bottom): Aₒ, Bₑ, Cₒ, Dₑ, Eₒ, Fₑ, Gₒ, and Hₑ.

Because the even and odd numbered pixels of sections B, D, F, and H are out of order after shuffle wherein the bitplane plane data of the even numbered pixels in these sections are located in the first 64 bits in their data entries, the bitplane data of the even and odd numbered pixels in these sections (B, D, F, and H) are exchanged, as shown in FIG. 11E. As a result, all bitplane data of the even numbered pixels are in the first 64 bits, and all bitplane data of the odd numbered pixels are in the second 64 bits.

The bitplane data of the first 64 bits and bitplane in the second 64 bits are combined respectively to be output to the pixel array of the spatial light modulator, as shown in FIG. 11F.

Alternative to the bitplane data retrieval process discussed above with reference to FIG. 11B to FIG. 11F wherein the resulted bitplane data are in the order from the top to bottom of A to H as shown in FIG. 11F, another bitplane data retrieval process with the resulted bitplane data in the order from the top to bottom of H to A is illustrated in FIG. 11G to FIG. 11K.

Referring to FIG. 11G, bitplane data are retrieved from the frame buffer in the same way as that shown in FIG. 11B as discussed before. The bitplane data of the even numbered pixels are located in the first four data entries, and the bitplane data of the odd numbered pixels are located in the following four data entries.

In the Data Queue, the bitplane data in the data entries each having 128 bits are separated. The bitplane data in the first 64 bits are reversed in order vertically. The reversed bitplane data in the order from the top to bottom: Gₒ, Eₒ, Cₒ, Aₒ, Gₑ, Eₑ, Cₑ, and Aₑ. The same reversing process is carried out for the bitplane data in the second 64 bits. The resulted bitplane data after reverse are in the order from the top to bottom: Hₒ, Fₒ, Dₒ, Bₒ, Hₑ, Fₑ, Dₑ, and Bₑ. Then the bitplane data in the first 64 bits of the last four entries (Gₑ, Eₑ, Cₑ, and Aₑ) are swamped with the bitplane data of the second 64 bits in the last four entries (Hₑ, Fₑ, Dₑ, and Bₑ). The resulted bitplane data after the above reversing processes are in the order from the top to bottom: (Gₒ, Eₒ, Cₒ, Aₒ, Hₑ, Fₑ, Dₑ, and Bₑ in the first 64 bits); and (Hₒ, Fₒ, Dₒ, Bₒ, Gₑ, Eₑ, Cₑ, and Aₑ in the second 64 bits), as shown in FIG. 11H.

The bitplane data after reversal processes in FIG. 11H are re-ordered according to their section indices in the order from the bottom to top, as shown in FIG. 11I. Referring to FIG. 11I, the re-ordered bitplane data in the first 64 bits are in the order from the bottom to top: Aₒ, Bₑ, Cₒ, Dₑ, Eₒ, Fₑ, Gₒ, and Hₑ. The bitplane data in the second 64 bits are in the order from the bottom to top: Aₑ, Bₒ, Cₑ, Dₒ, Eₑ, Fₒ, Gₑ, and Hₒ.

The bitplane data in FIG. 11I are shuffled such that all bitplane data for all even numbered pixels are in the first 64 bits, and the bitplane data for all odd numbered pixels are in the second 64 bits, as shown in FIG. 11J.

The shuffled bitplane data in FIG. 11J in the first 64 bits and second bits are then combined together to form bitplane data each having 128 bits depth, which is shown in FIG. 11K.

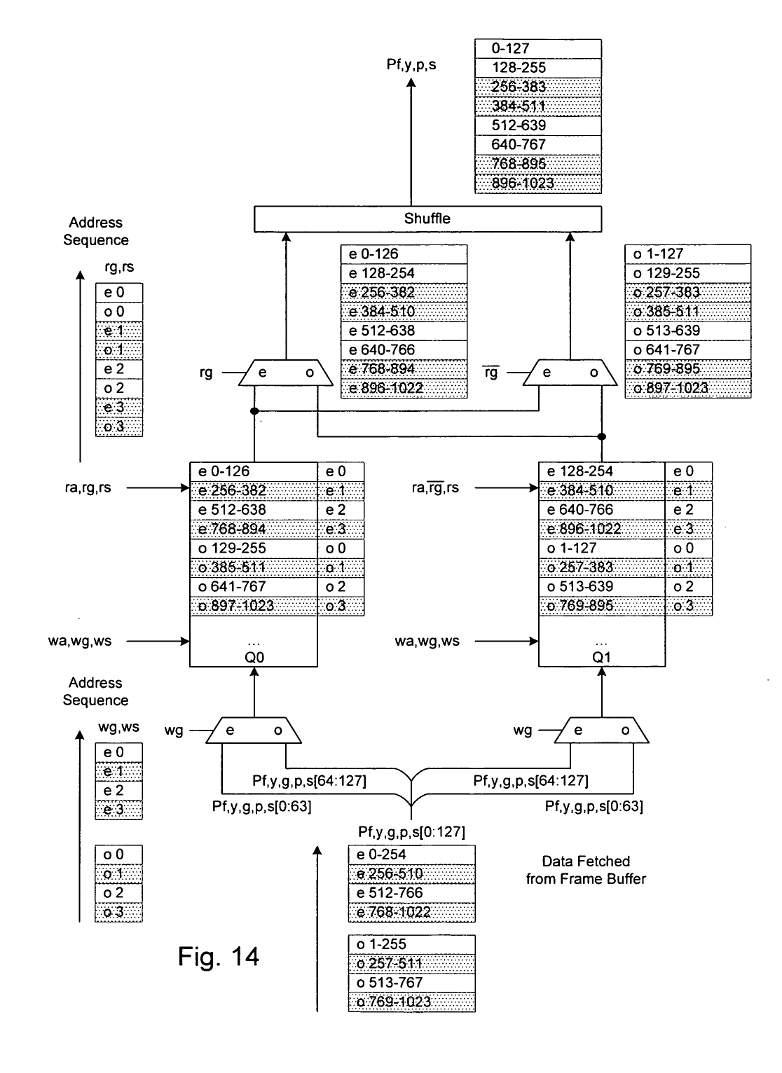

The above bitplane-data retrieval process can be implemented in many ways, one of which is illustrated in FIG. 14. Referring to FIG. 14, the bitplane data (P f y, g, p, s[0:127]) retrieved from the frame buffer are delivered to juxtaposed queues Q₀ and Q₁. Specifically, the first 64 bits [0:63] (64 Lest-Significant-Bits (LSBs)) are delivered to queue Q₀; and the second 64 bits [64:127] (64 Most-Significant-Bits (MSBs)) are delivered to queue Q₁. When the bitplane data is read out from these queues, the even and odd LSBs of a section(s) are read out synchronally and shuffled to form the full 128 LSBs of the section. The same process is carried out for the MSBs. The sections are read out in sequential order to form the full-row-plane of data.

With the above discussed image data processing processes, the image rotation can be achieved by manipulating the image data during the above image processing processes. In accordance with an embodiment of the invention, the image rotation can be achieved by reversing and/or swapping the corresponding bitplane data during a stage between formatting the image data into bitplane data and storing the bitplane data to the frame buffer (e.g. by the functional units of 202, 204, and 206 in FIG. 5). Alternatively, the image rotation can be achieved by reversing and/or swapping the bitplane data during a stage between retrieving the bitplane data from the frame buffer and delivering the bitplane data to the pixel array of the spatial light modulator (e.g. by the functional units of 214, 212, and 210 in FIG. 5).

In either instance, there are many possible methods to implement image rotation. In the present application, the rotation operation comprises FlipX function that flips the image along the X-axis in the screen coordinate; FlipY function that flips the image along the Y-axis in the screen coordinate; and a combination thereof. Of course, the method of the present invention can be generalized and adapted to rotations of other forms, such as flipping the image by any angles and/or along any axes in the screen coordinate or any combinations thereof.

FlipY Function

In one example, the FlipY function is operated by Write DMA 206 in FIG. 5 by reversing the row numbers. This function can be expressed by:
(Pf, y,s, p,g)→(Pf, \overline{y},s, p,g) (Equation 1), wherein
\overline{y}=N−y (Equation 2)
and N is the maximum index of the pixel rows of the image. In the example, as shown in FIG. 6, N is 768. For example, when the rows are numbered from 0-767, then the inverse of the row index is from 767-0, and N is 767.

The Write DMA unit in the video input side of the architecture counts out the row numbers as the video data arrives; and uses these row numbers to generate addresses to the frame buffer. The normal count direction is from 0 to N, where N is the maximum row index in the image. To flip the video vertically, the Write DMA unit may count the rows backwards, from N to 0. The DMA unit, rather than writing the bitplane data (Pf y, s, p, g) to the location in the frame buffer FB(f, y, g, p, s), writes the bitplane to the location FB(f, n−y, g, p, s), instead.

When such reversed bitplane data are retrieved from the frame buffer and delivered to the pixel arrays of the spatial light modulator, the projected image on the screen is flipped vertically as shown in FIG. 1B.

In another example, the FlipY function can be performed by Read DMA unit 210 in FIG. 5 by reversing the bitplane data using the same equations in equations 1 and 2. Specifically, the Read DMA unit in the display driving side of the architecture as shown in FIG. 5 receives row number pairs (yₑ, yₒ) from PWM engine 218. To flip the video image vertically, the Read DMA unit subtracts these row numbers from N the maximum row index N, (N−yₑ, N−yₒ). The Read DMA unit, rather than reading two half-row-plane data sets, (Pf. yₑ, e, pₑ) and (Pf, yₒ, o, Pₒ) from regions in the frame buffer FB(f, yₑ, e, pₑ) and FB(f, yₒ, o, pₒ), respectively, it reads the bitplane data sets from regions FB(f, N−yₑ, e, pₑ) and FB(f, N−yₒ, o, pₒ), instead.

When such reversed bitplane data are retrieved from the frame buffer and delivered to the pixel arrays of the spatial light modulator, the projected image on the screen is flipped vertically as shown in FIG. 1B.

In yet another example, the FlipY function can be performed by Command Queue 220 in FIG. 5 by reversing the bitplane data using the same equations in equations 1 and 2. The Command Queue in the display driving side of the architecture in FIG. 5 receives row number pairs (yₑ, yₒ) from PWM engine 218. To flip the video vertically, the Command Queue subtracts these row pairs from the N, (N−yₑ, N−yₒ). An disadvantage of this reversing scheme. When a color wheel (e.g. color wheel 104 in FIG. 2) presents in the projector system (e.g. the projection system in FIG. 2), the sweep of pixel addresses is desired to follow the direction of the spoke of the color wheel as it crosses the pixel array of the spatial light modulator of the display system. This method reversing the sweep of the addresses of the pixels may cause the pixel array of the spatial light modulator to be scanned in the direction opposite of the color wheel spoke, and therefore the spoke may not be hidden by blacking the rows under the spoke. This method can be used in other systems that would not have such a dependency.

FlipX Function

In an embodiment of the invention, the FlipX function is performed by Write DMA unit 206 in FIG. 5 by reversing the bitplane data of the rows before delivering the bitplane data to the frame buffer. Specifically, the FlipX function involves three steps. In the first step, the 128 bits in the sectioned-row-plane data (Pf y, s, p, g) produced by the transpose unit 204 are horizontally flipped. The bits in the transpose (204 in FIG. 5) output are numbered from 0 to 127. Using (Qf, y, s, p, g) representing the flipped bitplane data and i representing the bit index, the horizontal flip can be represented as the following assignment:
(Qf, y, s, p, g[i])=(Pf, y, s, p, g[127−i]) (Equation 3)
wherein f is the frame index, y is the pixel row index, s is the section index, p is the bitplane index; and g is the gender index (to identify even and odd numbered pixels).

In the second step, the Write DMA unit counts the section numbers (s) backwards. The DMA unit, instead of counting the section numbers from 0 to m, the DMA counts the section numbers from m to 0. m is the maximum section number (m=round (M/256)−1), where M is the total number of pixels in a row of the video image, such as 1024 the example shown in FIG. 6.

In the third step, the Write DMA unit inverts the even/odd gender (g). The Write DMA unit receives the data units (Pf, y, s, p, g) from the Transpose unit 204 (in FIG. 5) in the order of alternating even and odd genders. The Write DMA unit inverts the genders, i.e. assigns g=odd to the even numbered pixels; and g=even to the odd numbered pixels.

FIG. 12 and FIG. 13 illustrate the bitplane data of the video image in the normal direction and the bitplane data of the image that is flipped horizontally. As can be seen in FIGS. 12 and 13, the genders, section numbers, and the pixels numbers in the rows of the pixels are reversed, respectively.

In another example, the FlipX function is performed by Read DMA unit 210 in FIG. 5 by reversing the row data as it is fetched from the frame buffer. Specifically, the PWM engine 218 in FIG. 5 generates row numbers of the even and odd half-row-planes that are different from each other, because they are independently addressable in the pixel array of the spatial light modulator. Since a horizontal flip of the image rows causes the even and odd pixels to swap position, the even and odd row numbers need to be swapped, which can be achieved in many ways. For example, the (yₑ, pₑ) and (yₒ, pₒ) row numbers and plane number pairs delivered to the Read DMA unit by the PWM engine are swapped by swapping the yₑ and yₒ row numbers delivered to the Command Queue. Then the 128 bits bitplane data are horizontally flipped. Assuming Q represent the flipped bitplane data, P is the original bitplane data before such flipping; and i is the bit index, then such flip operation can be represented by the following equation:
Q[i]=P[127−i] (Equation 4)

This flip can be performed in several places in the display driving side of architecture. For example, the flip can be performed by flipping the half-row-plane-sections read from the frame buffer before storing in the Data Queue 212 in FIG. 5. Alternatively, the flip can be performed by flipping the full-row-plane-section LSBs/MSBs after the even/odd shuffled Data Queue output. Still alternatively, the flip can be performed by flipping the full-row-plane-section LSBs/MSBs inside the pixel array of the spatial light modulator.

The bitplane data after above flipping are processed by reversing the order of the section numbers in the Data Queue 212. Such process can be carried out in many places. For example, it can be performed in the Write DMA unit by counting the write section numbers backwards: ws=m−s.

In another example, it can be carried out in the Read DMA unit by counting the data queue read section numbers backwards: rs=m−s.

The bitplane data after reversing the section numbers are then processed by inverting the even/odd genders (g) in the Data Queue 212. This can be performed inb may ways.

For one example, it can be performed by inverting the data queue write gender: wg=even→odd, and odd→even. For another example, it can be carried out by inverting the data queue read gender: rg=even→odd, and odd→even.

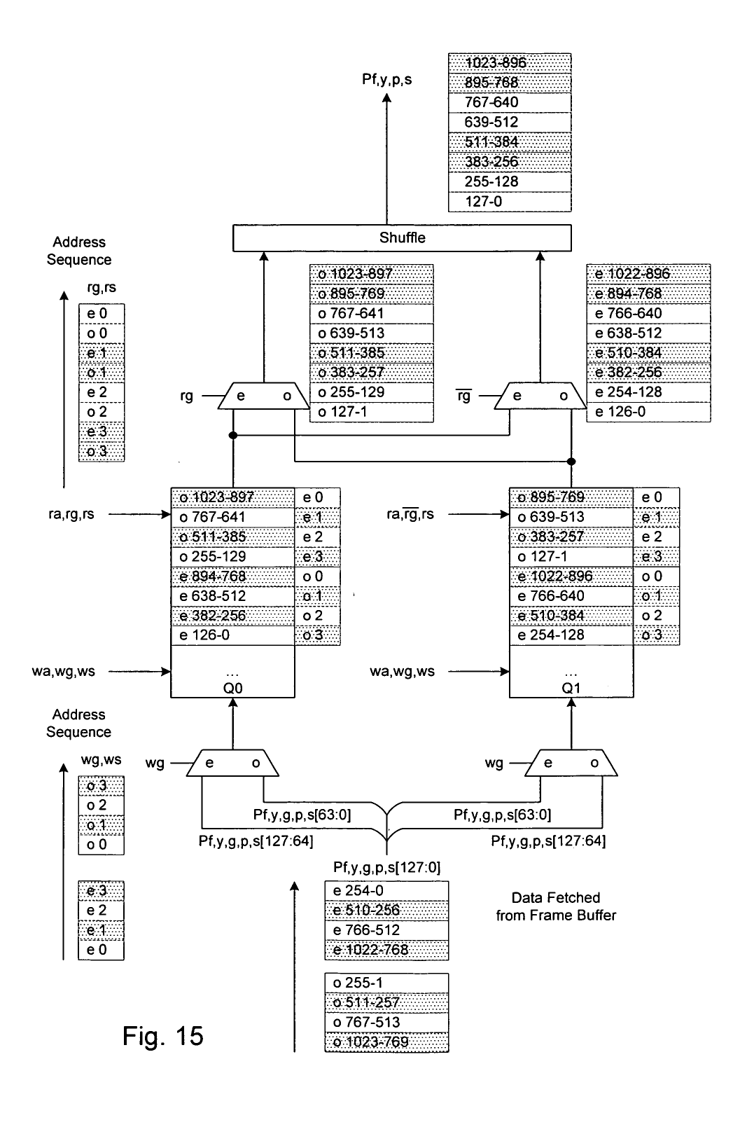

As a way of example, FIG. 15 illustrates the operation of Date Queue in performing the FlipX function as discussed above. Referring to FIG. 15, the bitplane data (Pf y, g, p, s[127:0]) retrieved from the frame buffer in an reversed order wherein the bit indices of the pixels are reversed, as compared to that in FIG. 14. The retrieved bitplane data are then delivered to the juxtaposed queues Q₀ and Q₁. Specifically, the 64 MSBs [127:64] are delivered to queue Q₀; and the 64 LSBs [63:0] are delivered to queue Qu. When the bitplane data is read out from these queues, the even and odd LSBs of a section(s) are read out synchronally and shuffled to form the full 128 MSBs of the section. The same process is carried out for the LSBs. The sections are read out in sequential order to form the full-row-plane of data.

In addition to the methods in performing the FlipX function, the FlipX function can be performed by other methods. In particular, there can be 24 different combinations of the four FlipX steps variations as discussed above. It turns out that if 128-bit horizontal flip is performed on the bitplane data fetched from the frame buffer, the gender inversion is desired to be performed on the data queues write address. If 128 bit flip is performed on the data after the shuffle, the gender inversion is desired to be performed on the data queues read address. Accordingly, the following step combinations are applicable in performing the FlipX function. In the following discussion, following annotations for the independent steps are to be used.

Step 1a—swap the (yₑ, pₑ) and (yₒ, pₒ) row number and plane number pairs delivered to the Read DMA unit by the PWM engine;

Step 1b—swap the yₑ and yₒ row numbers handed to the Command Queue by the PWM engine;

Step 2a—flip the half-row-plane-sections read from the frame buffer before storing in the Data Queue;

Step 2b—flip the full-row-plane-section LSBs/MSBs after the even/odd shuffled queue output data;

Step 2c—flip the full-row-plane-section LSBs/MSBs inside the microdisplay;

Step 3a—count the data queue write section number backwards: ws=m−s;

Step 3b—count the data queue read section number backwards: rs=m−s;

Step 4a—invert the data queue write gender: wg=even→odd; and odd→even; and

Step 4b—invert the data queue read gender: rg=even→odd; and odd→even.

In method alternative to the method of performing the FlipX function as discussed above, another method of performing the same comprises a sequence of steps of (Step 1a, Step 2a, Step 3a, Step 4a). In another example, another applicable sequence of steps comprises (Step 1a, Step 2a, Step 3b, and Step 4a). In yet another example, another applicable sequence of steps comprises: (Step 1a, Step 2b or Step 2c but not the both, Step 3a, and Step 4b). In yet another example, another applicable sequence of steps comprises: (Step 1a, Step 2b or 2c but not the both, Step 3b, and Step 4b). In yet another example, another applicable sequence of steps comprises: (Step 1b, Step 2a, Step 3a, and Step 4a). In yet another example, another applicable sequence of steps comprises: (Step 1b, Step 2a, Step 3b, and Step 4a). In yet another example, another applicable sequence of steps comprises: (Step 1b, Step 2b or 2c but not the both, Step 3a, and Step 4b). In yet another example, another applicable sequence of steps comprises: (Step 1b, Step 2b or 2c but not the both, Step 3b, and Step 4b).

It will be appreciated by those skilled in the art that a new and useful method and apparatus for rotating images in digital display systems have been described herein. In view of many possible embodiments to which the principles of this invention may be applied, however, it should be recognized that the embodiments described herein with respect to the drawing figures are meant to be illustrative only and should not be taken as limiting the scope of invention. For example, those of skill in the art will recognize that the illustrated embodiments can be modified in arrangement and detail without departing from the spirit of the invention. Therefore, the invention as described herein contemplates all such embodiments as may come within the scope of the following claims and equivalents thereof.

We claim:

1. A method of projecting an image, comprising:
providing a spatial light modulator with an array of pixels;
receiving a frame of image data of an image in a first orientation;
deriving a number of bitplane sectors from the image frame, each of which comprises first and second sets of bitplanes that are respectively associated with the even and odd numbered pixels of a row of the pixel array;
transforming the bitplanes so as to represent an image in a second orientation that is a horizontal flip of the first orientation, further comprising:
reversing the column order of the sectors in the row;
reversing the column order of the bitplanes in the first set of each sector;
reversing the column order of the bitplanes in the second set of each sector;
interleaving the bitplanes of the first and second sets in each sector; and
delivering the bitplanes of the first set to the even numbered pixels of the spatial light modulator with a first set of wordlines, and the bitplanes of the second set to the odd numbered pixels of the spatial light modulator with a second set of wordlines;
wherein the pixels of a row of the spatial light modulator are connected to different wordlines from the different wordline sets;
modulating a beam of incident light according to the first and second sets of bitplanes so as to projecting the image in the second orientation.

2. The method of claim 1, wherein the pixels are micromirror devices, each of which comprises a reflective and deflectable mirror plate attached to a deformable hinge such that the mirror plate is capable of moving relative to a substrate on which the mirror plate is formed.

3. The method of claim 2, wherein the substrate is a light transmissive substrate.

4. The method of claim 2, wherein the substrate is a semiconductor substrate having formed thereon an addressing electrode.

5. The method of claim 2, wherein each electrode is connected to a memory cell; and wherein the memory cells in each row are connected to first and second wordlines such that different wordlines are connected to different memory cells.

6. The method of claim 5, wherein the memory cells each comprise:
a transistor having a source, a drain, and a gate, wherein the source is connected to a bit-line; and the gate is connected to one of the first and second wordlines;
a capacitor with first and second plates, wherein the first plate is connected to the drain of the transistor; and
wherein the second plate is connected to a charging pumping signal whose voltage varies over time during a projection operation.

7. The method of claim 1, wherein the frame date of the image comprises standard RGB raster date.

8. The method of claim 1, wherein the image frame comprises a resolution of 1024×768 or higher; and wherein the total number of sectors is 4 or higher.

9. The method of claim 1, wherein a total number of bitplanes for each pixel is 64 or higher.

10. The method of claim 1, wherein the first set of bitplane data associated with the even numbered pixels are stored consecutively stored in a first segment of a frame buffer.

11. The method of claim 10, wherein the second set of bitplane data associated with the odd numbered pixels are stored consecutively stored in a second segment of the frame buffer.

12. A method of projecting an image, comprising:
providing a spatial light modulator with an array of pixels;
receiving a frame of image data of an image in a first orientation;
deriving a number of bitplane sectors from the image frame, each of which comprises first and second sets of bitplanes that are respectively associated with the even and odd numbered pixels of a row of the pixel array;
transforming the bitplanes so as to represent an image in a second orientation that is a vertical flip of the first orientation, further comprising:
reversing the row order of the bitplanes; and
delivering the bitplanes of the first set to the even numbered pixels of the spatial light modulator with a first set of wordlines, and the bitplanes of the second set to the odd numbered pixels of the spatial light modulator with a second set of wordlines;
wherein the pixels of a row of the spatial light modulator are connected to different wordlines from the different wordline sets;
modulating a beam of incident light according to the first and second sets of bitplanes so as to projecting the image in the second orientation.

13. The method of claim 12, wherein the pixels are micromirror devices, each of which comprises a reflective and deflectable mirror plate attached to a deformable hinge such that the mirror plate is capable of moving relative to a substrate on which the mirror plate is formed.

14. The method of claim 12, wherein the substrate is a light transmissive substrate.

15. The method of claim 12, wherein the substrate is a semiconductor substrate having formed thereon an addressing electrode.

16. The method of claim 13, wherein each electrode is connected to a memory cell; and wherein the memory cells in each row are connected to first and second wordlines such that different wordlines are connected to different memory cells.

17. The method of claim 16, wherein the memory cells each comprise:
a transistor having a source, a drain, and a gate, wherein the source is connected to a bit-line; and the gate is connected to one of the first and second wordlines;
a capacitor with first and second plates, wherein the first plate is connected to the drain of the transistor; and
wherein the second plate is connected to a charging pumping signal whose voltage varies over time during a projection operation.

18. The method of claim 12, wherein the frame date of the image comprises standard RGB raster date.

19. The method of claim 12, wherein the image frame comprises a resolution of 1024×768 or higher; and wherein the total number of sectors is 4 or higher.

20. The method of claim 12, wherein a total number of bitplanes for each pixel is 64 or higher.

21. The method of claim 12, wherein the first set of bitplane data associated with the even numbered pixels are stored consecutively stored in a first segment of a frame buffer.

22. The method of claim 21, wherein the second set of bitplane data associated with the odd numbered pixels are stored consecutively stored in a second segment of the frame buffer.

23. A method of projecting an image, comprising:

24. A method of projecting an image, comprising:
providing a spatial light modulator with an array of pixels;
receiving a frame of image data of an image in a first orientation;
deriving a number of bitplane sectors from the image frame, each of which comprises first and second sets of bitplanes that are respectively associated with the even and odd numbered pixels of a row of the pixel array;
transforming the bitplanes so as to represent an image in a second orientation that is a horizontal flip of the first orientation, further comprising:
reversing the column order of the sectors in the row;
reversing the column order of the bitplanes in the first set of each sector;
reversing the column order of the bitplanes in the second set of each sector;
interleaving the bitplanes of the first and second sets in each sector; and
reversing the row order of the bitplanes; and
delivering the bitplanes of the first set to the even numbered pixels of the spatial light modulator with a first set of wordlines, and the bitplanes of the second set to the odd numbered pixels of the spatial light modulator with a second set of wordlines;
wherein the pixels of a row of the spatial light modulator are connected to different wordlines from the different wordline sets;
modulating a beam of incident light according to the first and second sets of bitplanes so as to projecting the image in the second orientation.

25. The method of claim 24, wherein the step of reversing the row order of the bitplanes is performed before the step of reversing the column order of the sectors.

26. The method of claim 24, wherein the step of reversing the column order of the sectors in the row is performed after the steps of reversing the column order of the bitplanes in the first set of each sector; reversing the column order of the bitplanes in the second set of each sector; and interleaving the bitplanes of the first and second sets in each sector.
